(19) United States
(12) Patent Application Publication
(10) Pub. No.: US 2008/0254213 A1
(43) Pub. Date: Oct. 16, 2008

(54) Controlling ultra hard material quality

(76) Inventors: Feng Yu, Pleasant Grove, UT (US); Loel Corbett, Saratoga Springs, CA (US); Ronald K. Eyre, Orem, UT (US)

Correspondence Address: CHRISTIE, PARKER & HALE, LLP, PO BOX 7068, PASADENA, CA, 91109-7068, US

(21) Appl. No.: 12/080,839

(22) Filed: Apr. 4, 2008

Related U.S. Application Data
(62) Division of application No. 11/291,252, filed on Nov. 30, 2005.
(60) Provisional application No. 60/631,908, filed on Nov. 30, 2004.

(51) Int. Cl. B05D 3/02

(52) U.S. Cl. 427/190

(57) ABSTRACT

A method is provided for controlling the consistency of the quality of ultra hard materials formed over tungsten carbide substrates formed from different batches of tungsten carbide powder by controlling the tungsten carbide particle size distribution in each batch.

### CROSS-REFERENCE TO RELATED APPLICATION(S)

This application is a divisional of U.S. patent application Ser. No. 11/291,252, filed on Nov. 30, 2005, which is based upon and claims priority on U.S. Provisional Application No. 60/631,908, filed on Nov. 30, 2004, the contents of both of which are fully incorporated herein by reference.

### BACKGROUND OF THE INVENTION

Tungsten carbide substrates are formed by sintering tungsten carbide powder mixed with cobalt at sufficient temperature. Tungsten carbide substrate manufacturers are concerned with obtaining the requisite hardness, Magnetic Saturation and Coercivity from the substrates they make. However, the quality of an ultra hard material such as polycrystalline diamond (“PCD”) or polycrystalline cubic boron nitride (“PCBN”) formed on such tungsten carbide substrates varies from substrate to substrate. As such, a method for forming an ultra hard material having consistent quality, as for example, consistent strength and consistent minimum interface deformities, i.e., deformities at the interface between the ultra hard material and the substrate, such as cobalt eruptions, is desired. “Cobalt eruptions” are non-homogeneous dendritic tungsten carbide growths.

### SUMMARY OF THE INVENTION

A method for controlling the consistency of the quality of ultra hard materials formed over tungsten carbide substrates is provided. In an exemplary embodiment, the consistency is controlled by controlling the particle size distribution of the tungsten carbide particles forming the substrate. This can be accomplished by forming the ultra hard material over substrates which have a predetermined tungsten carbide particle size distribution.

In another exemplary embodiment, a method for controlling the infiltration kinetics into the ultra hard material during sintering is provided. In an exemplary embodiment the infiltration kinetics are controlled by selecting tungsten carbide substrates over which to form the ultra hard material which substrates have a predetermined particle size. In an exemplary embodiment, by controlling the tungsten carbide particle size distribution, a constant cobalt contribution is achieved in the substrate which is able to infiltrate the ultra hard material during sintering. In one exemplary embodiment, the present invention allows the strength of PCD layers formed over multiple carbide substrates to have a deviation of less than ±16% from layer to layer. In another exemplary embodiment, the consistency of the PCD strength is kept to a standard deviation of not greater than ±7%. In yet a further exemplary embodiment, the consistency of the PCD strength is kept to a standard deviation of not greater than ±5%.

In another exemplary embodiment a method is provided for controlling the quality of ultra hard material layers formed over a plurality of substrates formed from different batches of tungsten carbide powder. The method includes selecting a first batch of tungsten carbide substrate powder material having a predefined particle size distribution, and selecting a second batch of tungsten carbide substrate powder material having a predefined particle size distribution, such that deviation between the particle size distribution of the first batch and the particle size distribution of the second batch is no greater than about 30%. The method further includes forming a first substrate from the first batch of powder substrate material, forming a second substrate from the second batch of powder substrate material, placing a first ultra hard material over the first substrate, sintering the first ultra hard material powder with the first substrate forming a first ultra hard material layer over the first substrate, placing a second ultra hard material over the second substrate, and sintering the second ultra hard material powder with the second substrate forming a second ultra hard material layer over the second substrate, wherein a standard deviation of the strength of the two ultra hard material layers is not greater than 14%.

In another exemplary embodiment, the strength of the first ultra hard material layer does not differ from the strength of the second ultra material layer by more than 10%. In a further exemplary embodiment, the strength of the first ultra hard material layer does not differ from the strength of the second ultra material layer by more than 5%. In another exemplary embodiment, the hardness of the first substrate does not differ from the hardness of the second substrate by more than 2%. In yet a further exemplary embodiment, the hardness of the first substrate does not differ from the hardness of the second substrate by more than 0.5%. In yet a further exemplary embodiment, the magnetic saturation of the first substrate does not differ from the magnetic saturation of the second substrate by more than 15.4%. In yet another exemplary embodiment, the coercivity of the first substrate does not differ from the coercivity of the second substrate by more than about 43%.

In another exemplary embodiment, the two substrates have a hardness within 2% of each other, a magnetic saturation within 15% of each other, and a coercivity within 43% of each other. In yet another exemplary embodiment, each substrate has a carbide particle mean size in the range of 3 μm to 6 μm. In yet a further exemplary embodiment, each substrate has a carbide particle mean size of about 3 μm and a maximum particle size of about 18 μm. In one exemplary embodiment, each substrate has a carbide particle mean size of about 3 μm. In yet other exemplary embodiments the deviation between the two particle size distributions is not greater than about 20%, not greater than about 10%, and not greater than about 5%, respectively.

In another exemplary embodiment, each batch has 10% of its particles by volume having a size less than a first particle size, has 50% of its particles by volume having a size less than a second particle size, and has 90% of its particles by volume having a size less than a third particle size, wherein the deviation between the first particle sizes of the two batches is not greater than 5%, wherein the deviation between the second particles sizes of the two batches is not greater than 20% and wherein the deviation between the third particle sizes of the two batches is not greater than 30%.

In another exemplary embodiment, the method further includes selecting a third batch of tungsten carbide substrate powder material having a predefined particle size distribution, wherein the deviation between the particle size distribution of the first batch, the particle size distribution of the second batch, and the particle size distribution of the third batch is no greater than about 30%. The method also includes forming a third substrate from the third batch of powder substrate material, placing a third ultra hard material over the third substrate, sintering the third ultra hard material with the third substrate forming a third ultra hard material layer over the third substrate, wherein a standard deviation of the strength of the three ultra hard material layers is not greater than 14%. In a further exemplary embodiment, the strength of each ultra hard material layer is within 10% of the strength of each of the other ultra hard material layers. In another exemplary embodiment the strength of each ultra hard material layer is within 5% of the strength of each of the other ultra hard material layers. In yet other exemplary embodiments the deviation between the three particle size distributions is not greater than about 20%, not greater than about 10%, and not greater than about 5%, respectively. In a further exemplary embodiment, each batch has 10% of its particles by volume having a size less than a first particle size, has 50% of its particles by volume having a size less than a second particle size, and has 90% of its particles by volume having a size less than a third particle size, wherein the deviation between the first particle sizes of the three batches is not greater than 5%, wherein the deviation between the second particles sizes of the three batches is not greater than 20% and wherein the deviation between the third particle sizes of the three batches is not greater than 30%.

In an alternate exemplary embodiment, a method is provided for controlling the quality of ultra hard material layers formed over a plurality of substrates, each substrate formed from a different batch of tungsten carbide powder and cobalt. The method includes forming a first ultra hard material over a first substrate formed from a first batch of tungsten carbide powder, wherein cobalt from the first substrate infiltrates the first ultra hard material via infiltration kinetics during the forming of the first ultra hard material layer. The method also includes forming a second ultra hard material over a second substrate formed from a second batch of tungsten carbide powder, wherein cobalt from the second substrate infiltrates the second ultra hard material via infiltration kinetics during the forming of the second ultra hard material layer. The method further includes controlling the infiltration kinetics of the cobalt in the first substrate, and controlling the infiltration kinetics of the cobalt in the second substrate.

In another exemplary embodiment, controlling the infiltration kinetics of the cobalt in the first substrate includes controlling a first mean free path of the cobalt from the first substrate to the first ultra hard material layer and controlling the infiltration kinetics of the cobalt in the second substrate includes controlling a second mean free path of the cobalt from the second substrate to the second ultra hard material layer. In a further exemplary embodiment, controlling the first mean path includes selecting the first batch of tungsten carbide substrate powder material to have a predefined particle size distribution, and controlling the second mean path includes selecting the second batch of tungsten carbide substrate powder material to have a predefined particle size distribution, such that the deviation between the particle size distribution of the first batch and the particle size distribution of the second batch is no greater than about 30%. In yet further exemplary embodiments, the deviation between the two particle size distributions is not greater than about 20%, than about 10% and than about 5%, respectively.

In another exemplary embodiment, a method for controlling the quality of ultra hard material layers formed over a plurality of substrates formed from different batches of tungsten carbide powder is provided. The method includes selecting a first batch of tungsten carbide powder material having a particle size distribution, selecting a second batch of tungsten carbide substrate powder material having a particle size distribution, wherein the deviation between the particle size distribution of the first batch and the particle size distribution of the second batch is no greater than about 30%. The method also requires forming a first substrate from the first batch of material, forming a second substrate from the second batch of material, placing a first ultra hard layer material powder over the first substrate, sintering the first ultra hard material with a first substrate forming a first ultra hard material layer over the first substrate, placing a second ultra hard material over the second substrate, and sintering the second ultra hard material with a second substrate forming a second ultra hard material layer over the second substrate. In an exemplary embodiment, the first batch has particle sizes in the range of 2 μm to 11.5 μm and a median particle size in the range of 4.5 μm to 5.5 μm. In another exemplary embodiment the second batch has particle sizes in the range of 2 μm to 11.5 μm and a median particle size in the range of 4.5 μm to 5.5 μm. In yet a further exemplary embodiment, each batch has 10% of its particles by volume having a size less than a first particle size, has 50% of its particles by volume having a size less than a second particle size, and has 90% of its particles by volume having a size less than a third particle size, wherein the deviation between the first particle sizes of the two batches is not greater than 5%, wherein the deviation between the second particles sizes of the two batches is not greater than 20% and wherein the deviation between the third particle sizes of the two batches is not greater than 30%.

### BRIEF DESCRIPTION OF THE DRAWINGS

FIG. 1 is a schematic depiction of a particle size distribution of a tungsten carbide substrate.

FIGS. 2 and 3 are tables of specifications and data for various tungsten carbide substrates and PCD layers formed over such substrates, respectively.

### DETAILED DESCRIPTION OF THE INVENTION

Applicants have discovered that they can make more consistent better quality ultra hard material as for example polycrystalline diamond (“PCD”) or polycrystalline cubic boron nitride (“PCBN”) by controlling the tungsten carbide particle size distribution in tungsten carbide substrates over which the ultra hard material is formed.

Ultra hard material is formed by sintering ultra hard material particles over a tungsten carbide substrate at high pressure and high temperature where the ultra hard material is thermodynamically stable. These temperatures and pressures are typically in the range of 1300° C. to 1500° C. and 5 to 7 GPa, respectively. In one exemplary embodiment, to form an ultra hard material, a tungsten carbide substrate is placed in a refractory metal container such as a niobium container. Ultra hard material particles such as diamond or CBN are then placed over the substrate in the container. The container is covered with a cover made from the same material as the container. The container and its contents are then exposed to the temperatures and pressures where the ultra hard material is thermodynamically stable. The high temperature and pressure causes the ultra hard material particles with binder to convert to a polycrystalline ultra hard material.

Tungsten carbide substrates are formed by cementing together tungsten carbide particles in a cobalt binder matrix. During ultra hard material sintering, the cobalt in the substrate is “squeezed” from the tungsten carbide substrate and infiltrates the ultra hard material, e.g., diamond or cubic boron nitride. Applicants have discovered that the consistency in the cobalt infiltration kinetics determines the consistency of the quality of the ultra hard material sintering, and thus, the quality of the resulting polycrystalline ultra hard material. Infiltration kinetics are the kinetics that affect the infiltration of the cobalt from the tungsten carbide substrate to the ultra hard material layer. Infiltration kinetics are evaluated based on the amount of cobalt infiltrating the ultra hard material over a given time. By controlling the cobalt infiltration kinetics, i.e., by controlling the amount of cobalt that infiltrates the ultra hard material over a given time, applicants can control the amount of cobalt infiltrating the ultra hard material layer during a given time and a given temperature, and thus, control the quality and thus, the consistency of the quality of the ultra hard material. Applicants have also discovered that they can control the infiltration kinetics of the cobalt by controlling the mean free path of the cobalt from the substrate into the ultra hard material by controlling the tungsten carbide particle size distribution in the carbide substrate. In other words by controlling the tungsten carbide particle size distribution, the sweep of cobalt into the ultra hard material layer can be better controlled.

Thus, once a desired tungsten carbide particle size distribution is determined for optimum cobalt infiltration kinetics, the consistency of the quality of the ultra hard material formed over tungsten carbide substrates formed from different batches of tungsten carbide powder can be maintained by maintaining a consistent particle size distribution from batch to batch of tungsten carbide powder. In other words, by using batches of tungsten carbide powder having a consistent desired particle size distribution, the quality of ultra hard material layers formed over substrates formed from these batches will also be consistently better.

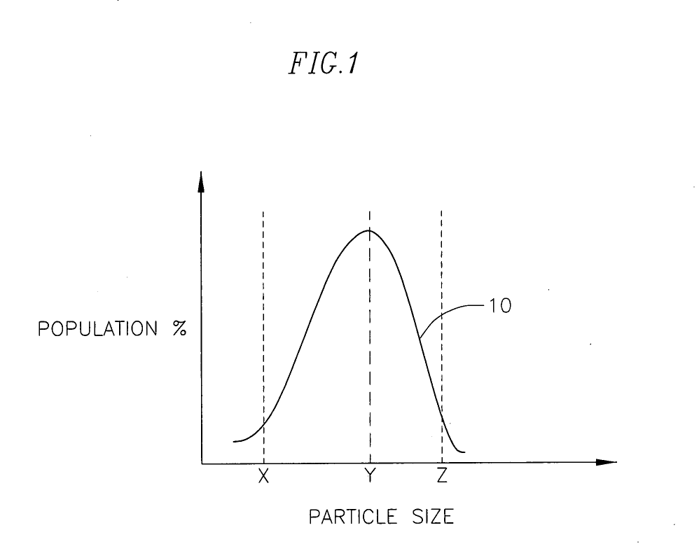

In general, tungsten carbide particle distribution in a tungsten carbide substrate follows a general curve as for example shown in FIG. 1. For a substrate material having the particle size distribution disclosed in FIG. 1, it may be said that the substrate has a mean particle size of Y with a majority of the particle distribution being between X and Z (i.e., the points of the curve where the curve turns toward the horizontal). In an exemplary embodiment, X is the 10% particles by volume point, Y is the 50% particles by volume point, and Z is the 90% particles by volume point. In other words, X is the point where 10% of the particles by volume have a particle size less than a particular value, Y is the point where 50% of the particles by volume have a particle size less than another value (the mean particle size), and Z is the point where 90% of the particles by volume have a particle size less than yet another value. In other exemplary embodiments, such 10%, 50% and 90% points may be at points on the distribution curve other than the X, Y, Z points. In yet further alternate exemplary embodiments, particle size distribution may be specified by specific amounts of particles having specific particle sizes or particle size ranges.

By tailoring the tungsten carbide particle size distribution, applicants believe that a consistent sweep of cobalt into the ultra hard material, i.e., a consistent amount of cobalt infiltrating the ultra hard material, can be achieved. Consequently, a consistent better quality of polycrystalline ultra hard material will be formed over such substrates. Thus, by selecting substrates with a specified tungsten carbide particle size distribution, a consistent sweep of cobalt from the substrate to the ultra hard material layer is achieved from substrate to substrate. Consequently, by using the same particle size distribution from substrate to substrate, or by using a similar particle size distribution from substrate to substrate such that the maximum deviation of particle size distribution between substrates is within a predetermined range, the resulting ultra hard material sintered on such substrates will be of consistent better quality. In other words, by using batches of tungsten carbide powder having consistent (i.e., the same or similar) particle size distributions, the quality of ultra hard material formed over such substrates will be consistently better.

Applicants believe that a consistent better quality of ultra hard material may be formed by keeping the deviation, i.e., the variation, of the particle size distribution from tungsten carbide powder batch to batch to no greater than 30%. Better consistent quality is believed to be obtained by reducing the deviation of the particle size distribution from batch to batch. For example, no deviation will produce a more consistent quality ultra hard material than a 5% deviation, which will produce a more consistent quality of ultra hard material than a 10% deviation, which will produce a more consistent quality of ultra hard material than a 20% deviation which will produce a more consistent quality of ultra hard material than a 30% deviation. “Deviation” as used in relation to the particle distribution herein refers to the deviation in the mean particle size and the deviation in the majority particle distribution when such factors are used to define the particle size distribution, or the deviation in the amount of particles having specific particle sizes or particle size ranges or the deviation in the particle sizes or particle size ranges when such factors are used to define the particle size distribution. For example, in the case where the particle size distribution is provided by looking at the 10%, 50%, and 90% particle levels, a given deviation would mean a given deviation in the 10% level, the 50% level, and the 90% level. Alternatively, one deviation may be given for the 10% level, another may be given for the 50% level and another may be given for the 90% level.

Applicants believe that during sintering of the tungsten carbide substrates, the carbon balance, the mixing of the cobalt and the cleanness of the sintering furnace used to sinter the tungsten carbide powder into a solid substrate should be controlled so as to achieve the desired cobalt infiltration kinetics. The carbon balance needs to be controlled during sintering of the substrate so that the carbon in the tungsten carbide powder remains stochiometric during sintering with the cobalt. Mixing of the cobalt with the tungsten carbide powder also needs to be controlled. Such mixing is typically performed with a mill. Overmixing with the mill will cause the particles in the tungsten carbide powder to significantly breakdown to smaller particles thereby significantly changing the particle size distribution of the powder.

A sintering furnace that is not cleaned of carbon may effect the carbon balance. Thus, it is important that during sintering of the tungsten carbide substrates, the carbon balance, the mixing of the cobalt and the cleanness of the sintering furnace should be properly controlled. Once the tungsten carbide particle size distribution and the aforementioned factors are controlled, the quality of the ultra hard material may be further controlled or fine tuned by controlling the particle size distribution of the of the ultra hard material particles forming the ultra hard material, thus, further controlling the mean free path of the cobalt from the substrate into the ultra hard material.

Polycrystalline ultra hard material formed using the inventive method will produce consistent strength and hardness, as well as a decrease in the interface deformities that are typically formed on the interface between the polycrystalline ultra hard material and the substrate, such as cobalt eruptions.

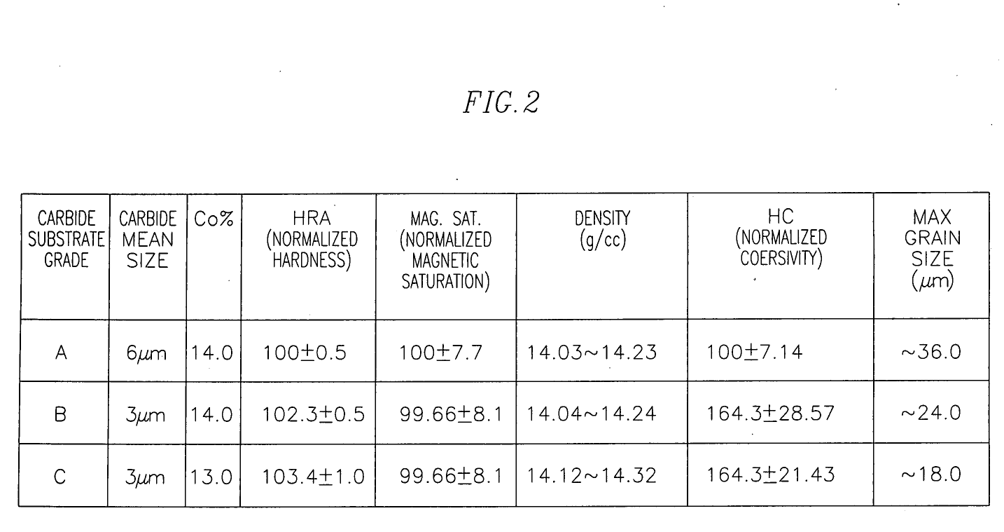

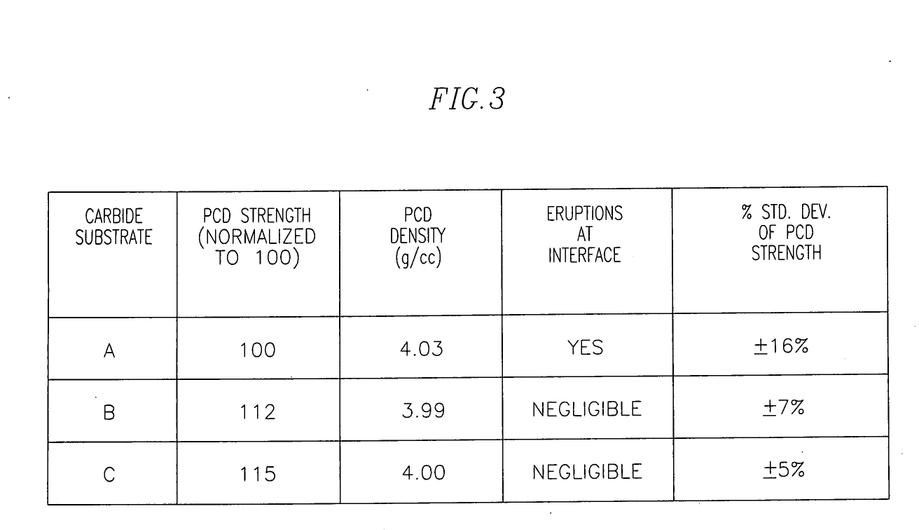

FIGS. 2 and 3 are tables of data of three current tungsten carbide substrate grades designated as carbide substrates A, B and C, respectively and of PCD layers formed over these three tungsten carbide substrates. The PCD grade, interface geometry, PCD layer geometry and sintering conditions were kept constant for each PCD layer formed over each of the three carbide substrates. The data in FIGS. 2 and 3 was obtained from over 1000 specimens having tungsten carbide substrates formed from different batches of tungsten carbide powder. Hardness, Magnetic Saturation, Coercivity and Strength data presented in FIGS. 2 and 3 have been normalized to the data in relation to substrate A. Consequently, Hardness, Magnetic Saturation, Coercivity and Strength data in relation to substrate A has a value of 100.

Substrate A had a tungsten carbide mean particle (grain) size of 6 μm and a maximum particle (grain) size of 36 μm. Carbide substrates B and C each had a tungsten carbide mean particle size of 3 μm and a maximum particle size of 24 μm and 18 μm, respectively. As can be seen from FIG. 3, all layers of PCD formed over the three tungsten carbide substrates had about the same density. However, as the particle size distribution changed, the strength of the PCD layers and the cobalt eruptions at the interface of the substrate and the PCD layer also changed. As can also be seen from FIG. 3, when the distribution of particle size was in a smaller range, e.g., up to about 18 μm (substrate C) versus up to about 36 μm (substrate A), the cobalt eruptions at the interface virtually disappeared. Furthermore, as can be seen in FIG. 3, the standard deviation of PCD strength based on data collected from multiple PCD layers formed over each of carbide substrates A, B and C, was reduced from about +16% for PCD layers formed over substrates A to about ±7% for PCD layers formed over substrates B, to ±5% for PCD layers formed over substrates C. In other words, the strength of each of the PCD layers formed over substrates C was within ±5% of the strength of each other PCD layer formed over substrates C. Thus, PCD layers with more consistent strength were formed over substrates C.

Applicants also believe that the quality of the polycrystalline ultra hard material can be improved by controlling the amount of cobalt content in the ultra hard material layer. Furthermore, applicants believe that by using a carbide particle size distribution having a smaller range in the substrate, the quality and the consistency in quality of the PCD formed will be improved without necessarily having to decrease the mean particle size. For example, applicants believe that the quality and consistency in quality of PCD formed over substrates having a mean carbide particle size of 6 μm but a maximum particle size of 18 μm, will be better than that of PCD formed over substrate A.

Applicants have also been able to get a consistent quality of ultra hard material formed over substrates which were formed from two different batches of tungsten carbide powder. The first batch had 10% of its particles by volume having a particle size of 2.4 μm or less, 50% of its particles by volume (i.e., having a mean particle size), having a particle size of 4.7 μm or less, and 90% of its particles by volume having a particle size of 8.8 μm or less. The second batch had 10% of its particles by volume having a particle size of 2.3 μm or less, 50% of its particles by volume having a particle size of 5.4 μm or less, and 90% of its particles by volume having a particle size of 11.2 μm or less. Applicants also believe they can get a high quality ultra hard material layer by forming it over a tungsten carbide substrate having a tungsten particle size range between 2 μm and 11.5 μm with a medium particle size in the range of 4.5 μm to 5.5 μm. Applicants further believe that they can get a high quality ultra hard material layer over tungsten carbide substrates formed from different batches of tungsten carbide powders where the deviation in the particle size distribution is not greater than 5% at that 10% level, not greater than 20% in the 50% level and not greater than 30% in the 90% level.

Moreover, Applicants believe that the deviation in magnetic saturation and hardness for tungsten carbide substrates formed from different batches of the same grade tungsten carbide powders, according to the principles of the present invention, as well as the deviation in the strength of ultra hard material layer formed over such substrates will be much lower than that depicted in FIGS. 2 and 3. Similarly the cobalt eruptions formed at the interface of PCD layers formed over such substrates will be negligible and at times non-existent. In fact it is expected that the deviation in the ultra hard material strength will be less than +5%.

Although the present invention has been described and illustrated to respect to multiple embodiments thereof, it is to be understood that it is not to be so limited, since changes and modifications may be made therein which are within the full intended scope of this invention as hereinafter claimed.

What is claimed is:

1. A method for controlling the quality of ultra hard material layers formed over a plurality of substrates formed from different batches of tungsten carbide powder, the method comprising:
selecting a first batch of tungsten carbide substrate powder material having a predefined particle size distribution;
selecting a second batch of tungsten carbide substrate powder material having a predefined particle size distribution, wherein the deviation between the particle size distribution of the first batch and the particle size distribution of the second batch is no greater than about 30%;
forming a first substrate from the first batch of powder substrate material;
forming a second substrate from the second batch of powder substrate material;
placing a first ultra hard material over the first substrate;
sintering the first ultra hard material with the first substrate forming a first ultra hard material layer over the first substrate;
placing a second ultra hard material over the second substrate; and
sintering the second ultra hard material with the second substrate forming a second ultra hard material layer over the second substrate, wherein a standard deviation of the strength of the two ultra hard material layers is not greater than 14%.

2. The method as recited in claim 1 wherein the strength of the first ultra hard material layer does not differ from the strength of the second ultra material layer by more than 10%.

3. The method as recited in claim 1 wherein the strength of the first ultra hard material layer does not differ from the strength of the second ultra material layer by more than 5%.

4. The method as recited in claim 1 wherein the hardness of the first substrate does not differ from the hardness of the second substrate by more than 2%.

5. The method as recited in claim 1 wherein the hardness of the first substrate does not differ from the hardness of the second substrate by more than 1%.

6. The method as recited in claim 1 wherein the magnetic saturation of the first substrate does not differ from the magnetic saturation of the second substrate by more than 15.4%.

7. The method as recited in claim 1 wherein the coercivity of the first substrate does not differ from the coercivity of the second substrate by more than about 43%.

8. The method as recited in claim 1 wherein the two substrates have a hardness within 1% of each other, a magnetic saturation within 15% of each other, and a coercivity within 43% of each other.

9. The method as recited in claim 1 wherein each substrate has a carbide particle mean size in the range of about 3 μm to 6 μm.

10. The method as recited in claim 9 wherein each substrate has a carbide particle mean size of about 3 μm and a maximum particle size of about 18 μm.

11. The method as recited in claim 1 wherein each substrate has a carbide particle mean size of about 4.5 μm to about 5.5 μm.

12. The method as recited in claim 1 further comprising:
selecting a third batch of tungsten carbide substrate powder material having a predefined particle size distribution, wherein the deviation between the particle size distribution of the first batch, the particle size distribution of the second batch, and the particle size distribution of the third batch is no greater than about 30%;
forming a third substrate from the third batch of powder substrate material;
placing a third ultra hard material over the third substrate;
sintering the third ultra hard material with the third substrate forming a third ultra hard material layer over the third substrate, wherein a standard deviation of the strength of the three ultra hard material layers is not greater than 14%.

13. The method as recited in claim 12 wherein the strength of each ultra hard material layer is within 10% of the strength of each of the other ultra hard material layers.

14. The method as recited in claim 12 wherein the strength of each ultra hard material layer is within 5% of the strength of each of the other ultra hard material layers.

15. The method as recited in claim 12 wherein the deviation between the three particle size distributions is not greater than about 20%.

16. The method as recited in claim 12 wherein the deviation between the three particle size distributions is not greater than about 10%.

17. The method as recited in claim 12 wherein the deviation between the two particle size distributions is not greater than about 5%.

18. The method as recited in claim 12 wherein each batch has 10% of its particles by volume having a size less than a first particle size, has 50% of its particles by volume having a size less than a second particle size, and has 90% of its particles by volume having a size less than a third particle size, wherein the deviation between the first particle sizes of the three batches is not greater than 5%, wherein the deviation between the second particles sizes of the three batches is not greater than 20% and wherein the deviation between the third particle sizes of the three batches is not greater than 30%.

19. The method as recited in claim 1 wherein the deviation between the two particle size distributions is not greater than about 20%.

20. The method as recited in claim 1 wherein the deviation between the two particle size distributions is not greater than about 10%.

21. The method as recited in claim 1 wherein the deviation between the two particle size distributions is not greater than about 5%.

22. The method as recited in claim 1 wherein each batch has 10% of its particles by volume having a size less than a first particle size, has 50% of its particles by volume having a size less than a second particle size, and has 90% of its particles by volume having a size less than a third particle size, wherein the deviation between the first particle sizes of the two batches is not greater than 5%, wherein the deviation between the second particles sizes of the two batches is not greater than 20% and wherein the deviation between the third particle sizes of the two batches is not greater than 30%.

23. A method for controlling the quality of ultra hard material layers formed over a plurality of substrates formed from different batches of tungsten carbide powder, the method comprising:
selecting a first batch of tungsten carbide powder material having a particle size distribution;
selecting a second batch of tungsten carbide substrate powder material having a particle size distribution, wherein the deviation between the particle size distribution of the first batch and the particle size distribution of the second batch is no greater than about 30%;
forming a first substrate from the first batch of material;
forming a second substrate from the second batch of material;
placing a first ultra hard layer material powder over the first substrate;
sintering the first ultra hard material with a first substrate forming a first ultra hard material layer over the first substrate;
placing a second ultra hard material over the second substrate; and
sintering the second ultra hard material with a second substrate forming a second ultra hard material layer over the second substrate.

24. A method as recited in claim 23 wherein the first batch has particle sizes in the range of 2 μm to 11.5 μm and a median particle size in the range of 4.5 μm to 5.5 μm.

25. A method as recited in claim 24 wherein the second batch has particle sizes in the range of 2 μm to 11.5 μm and a median particle size in the range of 4.5 μm to 5.5 μm.

26. The method as recited in claim 25 wherein each batch has 10% of its particles by volume having a size less than a first particle size, has 50% of its particles by volume having a size less than a second particle size, and has 90% of its particles by volume having a size less than a third particle size, wherein the deviation between the first particle sizes of the two batches is not greater than 5%, wherein the deviation between the second particles sizes of the two batches is not greater than 20% and wherein the deviation between the third particle sizes of the two batches is not greater than 30%.

27. The method as recited in claim 23 wherein each batch has 10% of its particles by volume having a size less than a first particle size, has 50% of its particles by volume having a size less than a second particle size, and has 90% of its particles by volume having a size less than a third particle size, wherein the deviation between the first particle sizes of the two batches is not greater than 5%, wherein the deviation between the second particles sizes of the two batches is not greater than 20% and wherein the deviation between the third particle sizes of the two batches is not greater than 30%.
